(19) United States
(12) Patent Application Publication
(10) Pub. No.: US 2025/0083995 A1
(43) Pub. Date: Mar. 13, 2025

(54) METHOD FOR COATING LARGE-AREA GLASS SUBSTRATES

(71) Applicant: Bühler Alzenau GmbH, Alzenau (DE)

(72) Inventors: Marcus FRANK, Sulzfeld (DE); Bernhard STALDER, Niederuzwil (CH)

(21) Appl. No.: 18/725,535

(22) PCT Filed: Dec. 23, 2022
(86) PCT No.: PCT/EP2022/025596

§ 371 Date: Jun. 28, 2024

(30) Foreign Application Priority Data
Jan. 4, 2022 (EP) 22150159.6

(51) Int. Cl. C03C 17/00

(52) U.S. Cl. CPC C03C 17/002; C03C 2218/119; C03C 2218/154; C03C 2218/31; C03C 2218/328; C03C 2218/34; C03C 2218/355

(57) ABSTRACT

A method for coating large-area glass substrates, the method having the following steps: a) applying a water-soluble layer to at least one first predetermined region of the surface of a glass substrate, wherein at least one second predetermined region of the surface of the glass substrate remains free of the water-soluble layer; b) coating the surface of the glass substrate with at least one non-water-soluble layer; c) removing the water-soluble layer, wherein steps a)-c) are carried out multiple times in succession.

The present disclosure relates to an iterative method for coating large-area glass substrates.

So-called lift-off methods (photolithography) using photoresists are known from microelectronics. In these methods, a photoresist is applied to a substrate and, using a mask, exposed at locations defined by the mask, and developed. The non-exposed locations of the photoresist are then removed using a corresponding solvent. In a further step, the substrate or the photoresist is coated with a material (alternatively, an etching method can be used to remove material). As the last step, the photoresist is removed from the substrate with a corresponding solvent, and the material layer applied to the photoresist is thus also removed. The substrate thus remains with the material layer at the locations at which the photoresist was not present during the coating.

Due to the complex working steps in the known methods (coating with photoresist, exposure, development), these methods are unsuitable in large-area coating.

Alternative masking technologies are applied industrially in the automotive sector. The masking layers are applied here by means of screen printing. In a further step, before the sputtering process, the masking layer is dried in an oven and subsequently provided with a low-emissivity (low-e) layer. After the coating, the masking layer is dissolved for a certain time and subsequently washed off together with the overlying layer.

The object of the present disclosure is to provide a method which, compared with the known methods, enables an efficient coating, in particular of large-area glass substrates.

This object is achieved with the features of the independent claims. The dependent claims relate to advantageous embodiments.

According to one aspect of the present disclosure, there is provided a method for coating large-area glass substrates, the method having the following steps: a) applying a water-soluble layer to at least one first predetermined region of the surface of a glass substrate, wherein at least one second predetermined region of the surface of the glass substrate remains free of the water-soluble layer; b) coating the surface of the glass substrate with at least one non-water-soluble layer; c) removing the water-soluble layer, wherein steps a)-c) are carried out multiple times in succession.

The method described above in the automotive field allows only a structured coating to be realized. In other words, a partial region of the substrate is provided after step c) with a sputtered (or an ion beam) coating, while the masked partial regions remain uncoated. If the method is repeated (iterative method) according to one aspect of the present disclosure, multiple different sputtered layers (depending on the number of iterations) can be arranged on the substrate (e.g. after three iterations, a red, green and blue filter (RGB)).

Different embodiments can preferably implement the following features.

The water-soluble layer is preferably not a photoresist.

The water-soluble layer is preferably water-soluble. Alternatively, further solvents (e.g. alcohols) can be used to remove the water-soluble layer. In other words, the water-soluble layer does not have to be exclusively water-soluble.

The glass substrate preferably has an area of 1 m² to 60 m², preferably 19 m² to 60 m², particularly preferably 19 m² to 39 m².

The size of a so-called tape measure (a standard dimension in the coating industry) for the glass substrate is preferably 3.21 m×6.00 m. Alternatively, the glass substrates can also be a size of 3.21 m×12 m or even 3.21 m×18 m. The downward dimensions can be limited by the spacings of the transport rollers. Typical minimum dimensions of the glass substrate are 1 m×1 m.

The step of coating preferably directly follows the step of applying the water-soluble layer.

In other words, preferably no further method steps, such as for example exposure and development, are carried out after the application of the water-soluble layer and before the coating. This also dispenses with the use and the disposal of the photoresist and developer chemicals. However, certain drying steps can be carried out for drying the water-soluble layer after the application of the water-soluble layer and before the coating. In other words, preferably at least no exposure and/or development steps are carried out after the application of the water-soluble layer and before the coating.

The application of the water-soluble layer is preferably carried out by a printing method, in particular by a screen printing method, an offset printing method, a rotary printing method or a digital printing method.

The water-soluble layer preferably has a higher surface tension in comparison with the surface energy of the glass substrate, so that a hydrophobic glass substrate property is produced. For example, the surface energy of purified soda glass is in the range of approximately 47 mJ/m². Thus, the surface tension of the water-soluble coating can preferably be in a range of >60 mJ/m². The present disclosure is not limited to this preferred example, and other ratios of the surface tension are also possible.

Furthermore, the surface tension can be optimized within wide ranges with corresponding additives.

The water-soluble layer preferably contains a water-soluble ink, preferably a water-soluble ink with dissolved colorant, and particularly preferably a pigment ink dispersed in water.

Preferably, the method has a step for reducing the surface energy of the surface of the glass substrate before step a), wherein the step for reducing the surface energy of the surface of the glass substrate preferably comprises plasma polymerization of hexamethyldisiloxane.

The coating of the surface of the glass substrate preferably comprises a directional coating method, preferably sputtering or ion beam coating.

The removal of the water-soluble layer preferably comprises the removal of the water-soluble layer and of the non-water-soluble layer located on the water-soluble layer.

The removal of the water-soluble layer is preferably carried out using a solvent, preferably a water-containing liquid.

The non-water-soluble layer is preferably also located on at least a portion of the water-soluble layer after the coating and mixes with the solvent when the water-soluble layer is removed using the solvent.

The step of removing the water-soluble layer preferably comprises a step for filtering the non-water-soluble layer in the solvent.

The removal of the water-soluble layer is preferably supported by a mechanical method, preferably brushing.

Preferably, the method has a step for cleaning the surface of the glass substrate before applying the water-soluble layer.

The first and second predetermined regions in a subsequent execution of steps a)-c) are preferably at least partially different from a preceding execution of steps a)-c) in order to arrange multiple structures, preferably optical filters, next to one another.

The above-mentioned aspects are explained in more detail below with reference to exemplary embodiments and the figures. The following is shown:

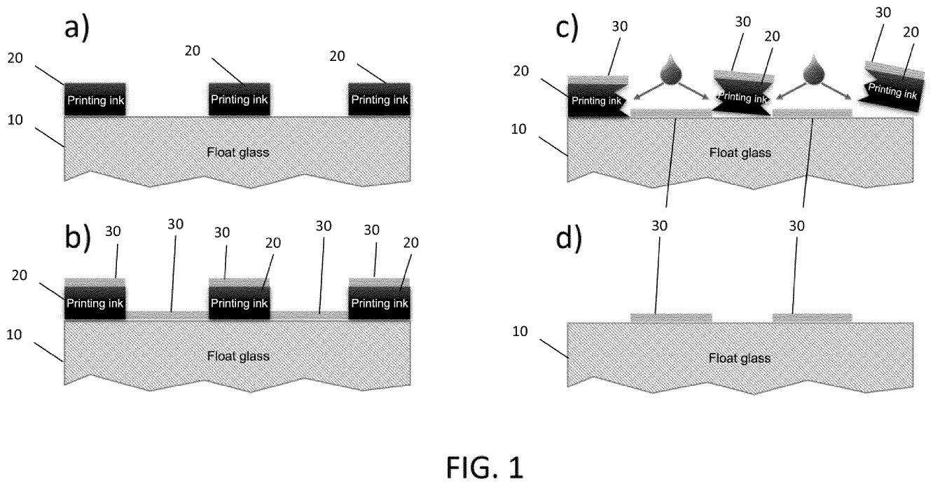

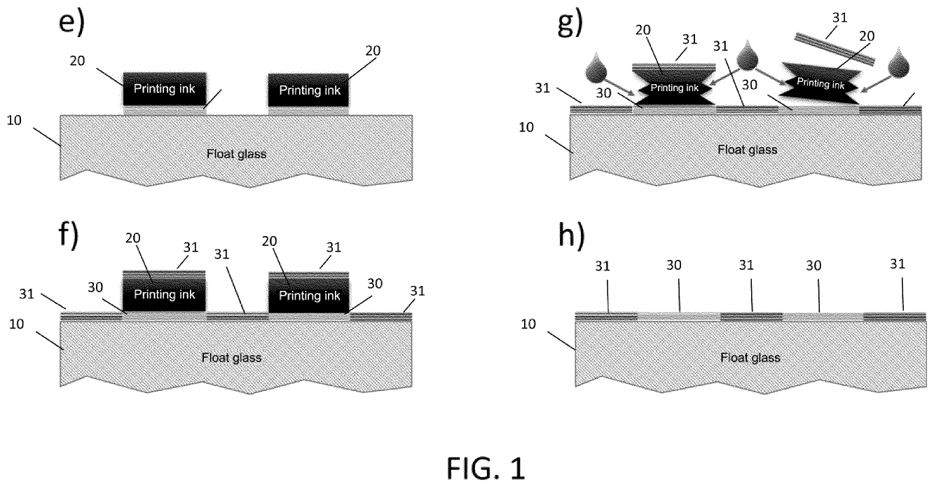

FIG. 1a)-d) a schematic representation of the method steps of a method according to an embodiment of the disclosure,

FIG. 1e)-h) a schematic representation of further method steps of a method according to an embodiment of the disclosure, and

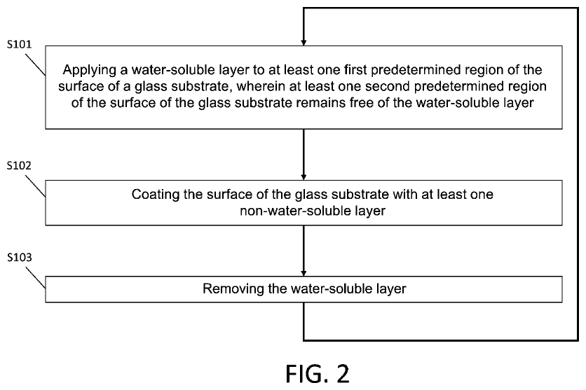

FIG. 2 a flowchart according to an embodiment of the disclosure.

FIGS. 1a)-d) show the steps of a method according to an embodiment of the disclosure. As can be seen in FIG. 1a), the printing ink 20 is applied to the glass substrate 10 at predetermined locations in a first step. According to FIG. 1b), a material 30 is applied. The material 30 is thus located on the glass substrate 10 (at the exposed locations) and on the printing ink 20. In a further step according to FIG. 1c), the printing ink 20 is detached from the glass substrate 10 by water or another solvent. In the process, the material 30 which is located on the printing ink 20 is also detached. The material 30 located on the glass substrate 10 remains on the glass substrate 10 and thus forms the desired structures on the glass substrate 10 as shown in FIG. 1d).

Further details and examples of the above-described steps of FIG. 1a)-d) are described below.

According to the disclosure, structured optical layers 30, for example, are produced on large areas (glass substrate 10) by replacing microlithographic steps with direct printing of water-soluble inks on a large substrate 10 (for example 3.21 m×6 m). After washing the glass substrate 10, a water-soluble layer 20 is printed (for example by screen printing, digital printing, etc.) on the areas on which the optical layer 30 is not desired. After the masking step, the printed substrate 10 is provided with an optical layer 30 (e.g. sputtering, vapor deposition, etc.). After the coating, the substrate 10 is washed again, whereby the masking layer 20 lying under the optical coating 30 dissolves in the water, and the optical layer 30 located thereon is likewise removed. The optical layer 30 is now located on the substrate 10 on the previously unprinted areas. The previously masked areas on the substrate 10 are free of any optical coating 30.

In contrast to methods in microelectronics, the present method is carried out on a significantly larger substrate size (sq m), and a different structural accuracy (˜100 μm) is demanded. Furthermore, in the present method, the masking is printed directly and does not have to be produced in a complicated manner by coating with photoresist, exposure and development.

In order to improve the detachment of the inks 20 after the coating, the following advantageous embodiments can be used with regard to masking ink, substrate material and coating method.

In order to achieve edges that are as steep as possible, it is possible for the printing ink 20 to have hydrophobic properties rather than wetting the glass substrate 10. Physically, this means that the printing ink 20 has a high surface tension. As a result of this property, high contact angles are achieved during printing and thus steep “masking edges” which are not covered with the coating material 30 during the subsequent coating. In addition, the masking ink 20 can be water-soluble and must not lose this property during the coating process, in particular not by vacuum coating methods (pressure <10 −3 mbar), the action of plasmas, UV irradiation and temperatures between 50° C. and 80° C. Particularly suitable are pigment inks dispersed in water, which after the evaporation of the water leave chalk-like layers which can be detached with water after coating. In order to achieve sufficient opacity, it is advantageous to increase the pigment or extender content of the printing ink 20 until a sufficient degree of coverage of the substrate 10 by the ink 20 is achieved. Alternatively, water-soluble inks with dissolved colorants, which have the same properties (opacity, surface tension), are also conceivable.

Alternatively or additionally, in order to achieve the high contact angles mentioned, the surface energy of the surface to be coated can be reduced by a suitable coating (for example by plasma polymerization of hexamethyldisiloxane (HMDSO)).

In order to avoid a situation in which steeply formed edges of the masking are not coated, “strongly directional” coating methods, preferably sputtering or ion beam coating, are suitable. Isotropic coating methods such as atomic layer deposition (ALD) or plasma-enhanced chemical vapor deposition (PECVD) are less suitable.

High demands are preferably likewise placed on the process step of detaching the printing ink 20 (FIG. 1c)) with the coating 30 located thereon. On the one hand, the printing ink 30 should be completely dissolved so that the coating 20 located thereon is completely separated from the substrate 10. If this is done with mechanical support (e.g. brushing), the ink 20 should be removed without mechanically damaging the underlying substrate 10 and the coating 30 remaining on the substrate 10 (scratches, breakouts at the edges of the coating structure) or even detaching them.

The process step of detaching can, for example, comprise: 1. The solvent (preferably water) is sprayed onto or poured over the substrate 10. To accelerate the process, the solvent can be warm (e.g. 30° C.); 2. The solvent remains on the substrate 10 until the printing ink 30 under the coating 20 has been dissolved as far as possible; 3. The solvent with the partially dissolved printing ink 30 and the coating 20 lying above it is rinsed with a further solvent, and the residues are removed completely with soft roller brushes (long, thin bristles).

After the successful removal of the printing ink 20 from the substrate 10, said printing ink is dissolved in the solvent. In addition, there are in the solvent portions of the coating 30 which were separated by the dissolution of the printing ink 20 from the substrate 10. These very small portions (˜10 μm-100 μm) should no longer reach the substrate 10 so that they do not deposit or dry on (adhesion) there. In order to avoid a high concentration of these coating particles in the solvent, they can preferably be filtered out of the solvent continuously. In addition to water-soluble substances, alternative solvents (e.g. alcohols or the like) can also be used for the lift-off step (FIG. 1c)).

As shown in the exemplary embodiment according to FIG. 1, in the first step (FIG. 1a)), a glass substrate 10 is partially printed with a water-soluble substance 20 (masking). In the second step (FIG. 1b)), the partially printed substrate 10 is coated with a layer 30 (for example an interference layer system). This interference layer system 30 can fulfill various functions (low-e, AR, dichroic filters or mirrors, etc.). After the coating (FIG. 1c)), the printed substance 30 is dissolved in a washing process and removed together with the interference layer system deposited thereon (lift-off). A substrate that is partially coated with an interference layer system remains (FIG. 1d)).

FIGS. 1e)-h) show further steps of the method according to an embodiment of the disclosure. The steps of FIG. 1e)-h) substantially correspond to a repetition of the steps of FIG. 1a)-d), but preferably the regions applied with printing ink 20 and/or the applied material 31 according to FIG. 1e)-h) differ at least in part from the regions or material 30 of the steps of FIG. 1a)-d).

As can be seen in FIG. 1e), the printing ink 20 is applied to the glass substrate 10 at predetermined locations (here at the locations of the first interference layer system 30) in a step following the step of FIG. 1d). According to FIG. 1f), a material 31 is applied, preferably a material 31 which differs from the material 30 from the steps of FIG. 1a)-d). The material 31 is thus located on the glass substrate 10 (at the exposed locations, e.g. at locations where the material 30 is not located) and on the printing ink 20. In a further step according to FIG. 1g), the printing ink 20 is detached from the glass substrate 10 by water or another solvent. In the process, the material 31 which is located on the printing ink 20 is also detached. The material 31 located on the glass substrate 10 remains on the glass substrate 10 and thus forms the desired structures on the glass substrate 10 as shown in FIG. 1h). Preferably, the regions with the material 31 are adjacent to regions with material 30. However, the material 31 can also lie in a region remote from the material 30, i.e. the material 31 cannot (or can only partially) be adjacent to the material 30.

The steps and conditions listed above with reference to FIG. 1a)-d) apply equally to the steps of FIG. 1e)-h) and are not repeated at this point.

FIG. 2 shows a flowchart with steps S101-S103 of a method for coating large-area glass substrates according to an embodiment of the disclosure. The method according to FIG. 2 has the following steps.
S101: applying a water-soluble layer to at least one first predetermined region of the surface of a glass substrate, wherein at least one second predetermined region of the surface of the glass substrate remains free from the water-soluble layer.
S102: coating the surface of the glass substrate with at least one non-water-soluble layer.
S103: removing the water-soluble layer.

Steps a)-c) are preferably carried out multiple times in succession.

In one embodiment, the glass substrate has an area of 1 m² to 60 m², preferably 19 m² to 60 m², particularly preferably 19 m² to 39 m².

In one embodiment, the step of coating directly follows the step of applying the water-soluble layer.

In one embodiment, the application of the water-soluble layer is carried out by a printing method, in particular by a screen printing method, an offset printing method, a rotary printing method or a digital printing method.

In one embodiment, the water-soluble layer has a higher surface tension in comparison with the surface energy of the glass substrate, so that a hydrophobic glass substrate property is produced.

In one embodiment, the water-soluble layer contains a water-soluble ink, preferably a water-soluble ink with dissolved colorant, and particularly preferably a pigment ink dispersed in water.

In one embodiment, the method has a step for reducing the surface energy of the surface of the glass substrate before step a), wherein the step for reducing the surface energy of the surface of the glass substrate preferably comprises plasma polymerization of hexamethyldisiloxane.

In one embodiment, coating the surface of the glass substrate comprises a directional coating method, preferably sputtering or ion beam coating.

In one embodiment, the removal of the water-soluble layer comprises the removal of the water-soluble layer and of the non-water-soluble layer located on the water-soluble layer.

In one embodiment, the removal of the water-soluble layer is carried out using a solvent, preferably a water-containing liquid.

In one embodiment, the non-water-soluble layer is also located on at least a portion of the water-soluble layer after the coating and mixes with the solvent when the water-soluble layer is removed using the solvent.

In one embodiment, the step of removing the water-soluble layer comprises a step for filtering the non-water-soluble layer in the solvent.

In one embodiment, the removal of the water-soluble layer is supported by a mechanical method, preferably brushing.

In one embodiment, the method has a step for cleaning the surface of the glass substrate before applying the water-soluble layer.

In one embodiment, the first and second predetermined regions in a subsequent execution of steps a)-c) are at least partially different from a preceding execution of steps a)-c) in order to arrange multiple structures, preferably optical filters, next to one another.

Although the disclosure is illustrated and described in detail by means of the figures and the associated description, this illustration and this detailed description are to be understood as illustrative and exemplary, and not as limiting the disclosure. It is understood that those skilled in the art may make changes and modifications without departing from the scope of the following claims. In particular, the disclosure also comprises embodiments having any combination of features that are mentioned or shown above with respect to various aspects and/or embodiments.

The disclosure also includes individual features in the figures, even if they are shown there in connection with other features and/or are not mentioned above.

Furthermore, the term “comprise” and derivatives thereof do not exclude other elements or steps. Likewise, the indefinite article “a” or “an” and derivatives thereof do not exclude a plurality. The functions of a plurality of features listed in the claims may be fulfilled by one unit. The terms “substantially,” “around,” “approximately,” and the like in conjunction with a property or a value also define in particular precisely the property or precisely the value. None of the reference signs in the claims are to be understood as limiting the scope of the claims.

1. A method for coating large-area glass substrates, the method having the following steps:
a) applying a water-soluble layer to at least one first predetermined region of the surface of a glass substrate, wherein at least one second predetermined region of the surface of the glass substrate remains free from the water-soluble layer;
b) coating the surface of the glass substrate with at least one non-water-soluble layer;
c) removing the water-soluble layer, wherein steps a)-c) are carried out multiple times in succession.

2. The method according to claim 1, wherein the glass substrate has an area of 1 m² to 60 m², preferably 19 m² to 60 m², particularly preferably 19 m² to 39 m².

3. The method according to claim 1, wherein the step of coating directly follows the step of applying the water-soluble layer.

4. The method according to claim 1, wherein the application of the water-soluble layer is carried out by means of a printing method, in particular by means of a screen printing method, an offset printing method, a rotary printing method or a digital printing method.

5. The method according to claim 1, wherein the water-soluble layer has a higher surface tension in comparison with the surface energy of the glass substrate, so that a hydrophobic glass substrate property is produced.

6. The method according to claim 1, wherein the water-soluble layer contains a water-soluble ink, preferably a water-soluble ink with dissolved colorant, and particularly preferably a pigment ink dispersed in water.

7. The method according to claim 1, having a step for reducing the surface energy of the surface of the glass substrate before step a), wherein the step for reducing the surface energy of the surface of the glass substrate preferably comprises plasma polymerization of hexamethyldisiloxane.

8. The method according to claim 1, wherein coating the surface of the glass substrate comprises a directional coating method, preferably sputtering or ion beam coating.

9. The method according to claim 1, wherein the removal of the water-soluble layer comprises the removal of the water-soluble layer and of the non-water-soluble layer located on the water-soluble layer.

10. The method according to claim 1, wherein the removal of the water-soluble layer is carried out using a solvent, preferably a water-containing liquid.

11. The method according to claim 10, wherein the non-water-soluble layer is also located on at least a portion of the water-soluble layer after the coating and mixes with the solvent when the water-soluble layer is removed using the solvent, wherein the step of removing the water-soluble layer comprises a step for filtering the non-water-soluble layer in the solvent.

12. The method according to claim 1, wherein the removal of the water-soluble layer is supported by a mechanical method, preferably brushing.

13. The method according to claim 1, comprising a step for cleaning the surface of the glass substrate before applying the water-soluble layer.

14. The method according to claim 1, wherein the first and second predetermined regions in a subsequent execution of steps a)-c) are at least partially different from a preceding execution of steps a)-c) in order to arrange multiple structures, preferably optical filters, next to one another.
